(19) United States
(12) Patent Application Publication
(10) Pub. No.: US 2022/0102815 A1
(43) Pub. Date: Mar. 31, 2022

(54) ENABLING BENEFICIAL ELECTRICAL CONNECTIONS WITHIN JELLY ROLL OF BATTERY MATERIALS END PLATE USING AT LEAST ONE OF TABLESS-STYLE ELECTRODE AND IRREGULAR PROCESS-INDUCED TABS

(71) Applicant: James E. Beecham, West Palm Beach, FL (US)

(72) Inventor: James E. Beecham, West Palm Beach, FL (US)

(21) Appl. No.: 17/546,501

(22) Filed: Dec. 9, 2021

Related U.S. Application Data
(62) Division of application No. 17/329,014, filed on May 24, 2021.
Application No. 17/329,014 is a continuation-in-part of application No. 17/114,222, filed on Dec. 7, 2020, now abandoned.
Application No. 17/114,222 is a continuation-in-part of application No. 17/108,969, filed on Dec. 1, 2020.
Application No. 17/108,969 is a continuation-in-part of application No. 17/102,226, filed on Nov. 23, 2020.
Application No. 17/102,226 is a continuation-in-part of application No. 17/092,035, filed on Nov. 6, 2020, now abandoned.
Application No. 17/092,035 is a continuation-in-part of application No. 17/064,243, filed on Oct. 6, 2020, now abandoned.
Application No. 17/064,243 is a continuation-in-part of application No. 17/033,853, filed on Sep. 27, 2020, now abandoned.
Application No. 17/033,853 is a continuation-in-part of application No. 16/867,273, filed on May 5, 2020, now Pat. No. 10,800,434.

(51) Int. Cl. H01M 50/536; H01M 50/538

(52) U.S. Cl. CPC H01M 50/536; H01M 50/538

(57) ABSTRACT

A method and system for enabling beneficial electrical connections within end plate of jelly roll of battery materials by use of arbitrary combinations of irregular tabs within tabless-style electrode. A more efficient flow of electrons is also enabled as compared to welded single tab batteries. Furthermore, the instant invention improves battery heat management via core-cooling effect.

### CROSS-REFERENCE TO RELATED APPLICATION

This application is a divisional application of Ser. No. 17/526,276 filed Nov. 15, 2021 which claims priority to non-provisional application Ser. No. 17/114,222, entitled BATTERY COMPRISING ELECTRODE WITH LASER-SINTERED MATERIAL AND AT LEAST ONE HUNDRED ELECTRODE EXTENSIONS filed 19 May 2021 by instant inventor, which claims priority to non-provisional application Ser. No. 17/108,969 filed 1 Dec. 2020 by instant inventor, entitled STARWHEEL-ENABLED ASSEMBLING OF LONG-LIFE BATTERIES, which claims priority to non-provisional application Ser. No. 17/102,226 filed 23 Nov. 2020 by instant inventor, entitled CONFIGURING AND MAINTAINING SHINGLED OVERLAPS OF ELECTRODE EXTENSIONS AT END PLATE OF JELLY ROLL OF BATTERY MATERIALS, which claims priority to non-provisional application Ser. No. 17/092,035 filed 6 Nov. 2020 by instant inventor, entitled ELECTRODE EXTENSION OVERLAP CONFIGURATIONS IN BATTERY, which claims priority to non-provisional application Ser. No. 17/064,243 filed 6 Oct. 2020 by instant inventor, entitled ELECTRIC VEHICLE BATTERY PACKS COMPRISING TABLESS/MULTI-TAB CYLINDRICAL JELLY-ROLL STYLE BATTERY CELLS, which claims priority to non-provisional application Ser. No. 17/033,853 filed 27 Sep. 2020 by instant inventor, entitled ELECTRIC VEHICLE SAFETY AS TO SIDE COLLISIONS AND BATTERY PACK PLACEMENT IN MANUFACTURING, whereby each referenced application is incorporated in its entirety at least by reference.

### 1. FIELD OF THE INVENTION

The present invention generally relates to jelly roll of battery materials. More specifically, present invention relates to enabling beneficial electrical connections within end plate of jelly roll of battery materials using at least one of irregular process-induced tabs and tabless-style electrode.

### BRIEF SUMMARY OF THE INVENTION

A metal foil electrode configured in a tabless design, is an electrode without welding on of metal tab to foil electrode or purpose-cutting or etching of tabs in foil electrode. In general parlance for purpose of context herein, a tab is defined as a short projecting device such as a flap or appendage. In battery-related parlance, a tab in a battery is typically defined as a metallic component which connects the current collector foil to the external circuit.

In a preferred embodiment, instant invention comprises a cylindrical battery jelly roll of battery materials end plate wherein said end plate comprises use of arbitrary combinations of electrode elements in promoting beneficial electrical contacts. Such arbitrary combinations of electrode elements, as hereinafter disclosed, enable such beneficial electrical connections to occur, as disclosed herein according to instant invention system and method.

Such arbitrary combinations of electrode elements rendered into beneficial electrical are typically enabled by means comprising at least one of layering of tabless-style electrode within winding of jelly roll and layering of irregular process-induced tabs within winding of jelly roll. Said layering is further disclosed below.

In a preferred embodiment, said arbitrary combinations enabling beneficial electrical contacts involve electrode element faces, as further disclosed below. It is understood that the term face in describing an element of an electrode refers to a tab-like structure with thickness typically approximating 10 microns and having a discernable width thereby providing a front face aspect and a rear face aspect. See FIGS. 1 and 2 for additional details.

In a preferred embodiment, a tabless-style electrode pre-processing refers to an electrode which comprises metal foil, typically aluminum or copper, said foil electrode having rectangular shape and smooth edges by naked eye observation. Said tabless-style electrode, is typically a 10-micron thick rectangular extent of foil without weld-attached metal tab.

Said tabless-style electrode, is typically prepared as suitable to accept covering in one area of metal powder, such as to be sintered for example. Said tabless-style electrode typically comprises along one lengthwise border an uncoated area to serve as current collector.

Typically, at least upon initial manufacture, said tabless-style electrode foil layer has no observable fissures or holes or irregular edges. That is the tabless-style electrode's condition before its processing, such as processing in preparing said electrode for use a cylindrical battery.

In a preferred embodiment, instant invention comprises establishing said beneficial electrical connections within end plate of wound jelly roll of battery materials by using arbitrary combinations, as herein disclosed. Said beneficial electrical connections can comprise electrode tabs in face-to-face contact. Tabs within said face-to-face contact can be irregular in shape and size. Such contact within said face-to-face contacts can be partial, such as wherein one portion of a face of a first element is applied in electrical connections to a portion of face of other element.

Said beneficial electrical connections develop in arbitrary combinations, as herein disclosed, associated with elements of irregular tab structure originating during stresses of processing of electrode. Such irregularities of tabs typically accompany appearance within processed electrode of cracks, holes, splits, fissures, and fractures. Such small irregular shaped-tabs or shallow tabs develop in the foil of the electrode during processing, and as herein disclosed are applied by instant method and system to comprise arbitrary combinations of electrical connections within end plate of jelly roll of battery materials, said connections comprising tabless-style electrode.

In a preferred embodiment, instant invention discloses such arbitrary combinations as causing an assembly to form within end plate wherein a central electrode element receives face-to-face electrical contact of at least two faces of elements of said same electrode onto upper face of said central element of tabless-style electrode. In a preferred embodiment, instant invention comprises said beneficial electrical connections further comprising for said central electrode element, simultaneously receiving face-to-face electrical contact of at least two other faces of other elements of said same electrode onto lower face of said central element.

In a preferred embodiment, a method is disclosed for assembling within end plate of jelly roll of battery materials, such arbitrary combinations of beneficial electrical connections comprising tabless-style electrode. Such method comprises step of layering of arbitrary numbers and configurations of process-induced irregular tabs within a first layer of electrode onto a preceding layer of same electrode with same features of arbitrary numbers and configurations of process-induced irregular tabs.

In a preferred embodiment, such arbitrary combinations enable variety of electrical connections. In a preferred embodiment, such variety comprises at least one assembly wherein a central electrode element has face-to-face electrical contact with at least four other electrode element faces of tabless-style electrode.

In a preferred embodiment, a method and system are disclosed wherein said central electrode element of tabless-style electrode is enabled to receive face-to-face electrical contact of at least two faces of elements of said same electrode onto upper face of said central element, and simultaneously same central element is enabled to receive face-to-face electrical contact of at least two other faces of other elements of said same electrode onto lower face of said central element.

### BRIEF DESCRIPTION OF THE FIGURES

Other features and advantages of the present invention will become apparent when the following detailed description is read in conjunction with the accompanying drawings, in which:

FIG. 1 is a schematic illustrating details of a preferred embodiment.

FIG. 2 is a schematic illustrating details of a preferred embodiment.

### DETAILED DESCRIPTION OF PREFERRED EMBODIMENTS

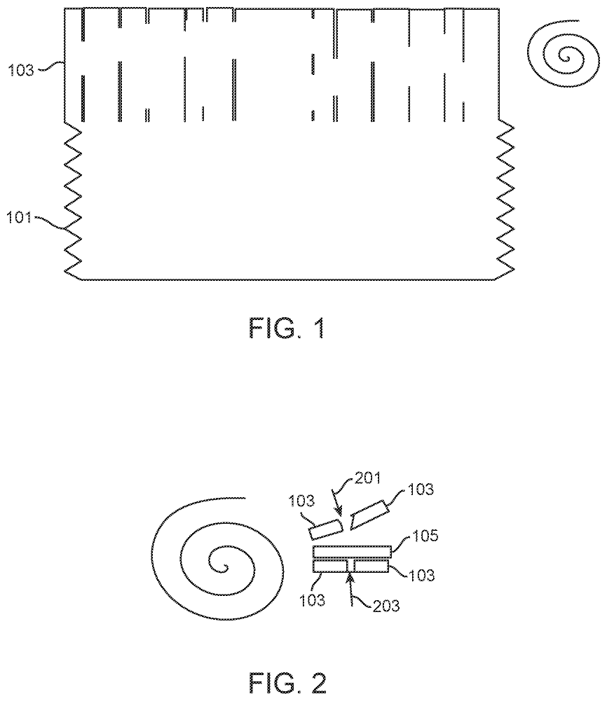

In FIG. 1, a schematic of a preferred embodiment of instant invention is illustrated wherein a tabless-style electrode 101 of cylindrical battery is viewed in theoretical un-rolled appearance on left of FIG. 1. The spiral on right of FIG. 1 represents the winding of jelly roll, a condition partially complete and from which the foil layer was theoretically unwound for purposes of illustration as left side of FIG. 1 discloses. The tabless-style electrode is illustrated as viewed from front of long rectangular extent. The FIG. 1 theoretical un-rolled view of tabless-style electrode 101 represents the condition of said tabless-style electrode as it might exist within the partially wound electrode of the jelly roll, represented by the partially wound spiral. The spiral schematic represents the winding of the jelly roll of battery materials in partially completed status. The view of the spiral represents perspective view from above the jelly roll being wound, a view of schematic along the long axis of the cylindrical battery.

It is understood that the electrode illustrated in spiral is same as electrode illustrated in unwound schematic. It is understood that this tabless-style electrode 101 has completed at least one step of process of preparation for use in jelly roll of battery materials prior to the illustrated winding. Such at least one step could be of list: single-side electrode coating of active materials applied, double-side coating of active materials applied, manipulating of this tabless-style electrode carried out using rollers, in-tension processing carried out, heat drying of this tabless-style electrode carried out, wet coating process carried out on this tabless-style electrode, dry coating process carried out on this tabless-style electrode.

Thus, FIG. 1 illustrates a tabless-style electrode comprising condition as would exist in moment of its use within winding of jelly roll of battery materials. It is understood that the FIG. 1 spiral schematic and the FIG. 1 unwound view are views of same tabless-style electrode.

The said tabless-style electrode 101 of FIG. 1, in the theoretical un-rolled view, comprises an area 107 of electrode 101, said area 107 serving as uncoated electrical collection area. Said area 107 also comprises the spiral wound electrode, not separately numbered in schematic. Thus, the 107 portion of the partially wound electrode comprises a partially wound ‘end plate’ of the jelly roll materials.

The spiral to top right of diagram can thus be taken to represent the winding process wherein the said tabless-style electrode is being rendered into jelly roll configuration of battery materials in preparation to placing said wound jelly roll into battery case (not shown). Such other elements of battery materials of typical jelly roll are also present (not shown), and typically comprise a second electrode (possibly a second tabless-style electrode), one or more separators (not shown), coverings of pressed/sintered powders (not shown).

In area 107, the schematic rendering of theoretically un-rolled or unwound metal foil electrode, such tabless-style electrode is illustrated to have cracks, holes, and irregular tab formations which are naked-eye visible as narrow 103 or wide 105. Such illustrated variation in tab shape and size is characteristic within instant invention. Such variation contributes to establishing instant invention arbitrary combinations of electrical connections between elements of wound tabless-style electrode, as herein disclosed.

It is understood that FIG. 1 is not to scale. It is understood that other irregular tab shapes and distributions are possible in electrode foil within the scope of instant invention.

Such irregular tabs can comprise results of several factors of stress on foil of electrode. Such factors can include the stress of tension and torsion, such as placed on foil of electrode during pre-winding processing, as well as during winding.

It is understood that the thickness of metal foil of said tabless-style electrode is a factor in the development of said irregular tabs as shown 103 and 105. It is understood that the manner and condition of preparation of said tabless-style electrode, such as the temperature of winding environment, application of active materials, are factors in amounts and distribution of irregular tabs as herein disclosed.

Within instant invention, other steps which may result in said tabless-style electrode comprising irregular tabs include use of dual side coatings, use of tension on foil during rolling process on rollers, use of dry powder process, use of wet coating process with heat drying.

In FIG. 2, a schematic of a preferred embodiment of instant invention is illustrated wherein a spiral is illustrated to left of FIG. 2, said spiral representing a partially wound tabless-style electrode (shown) within a partially wound jelly roll of other battery materials (not shown). To the right side of the spiral is illustrated elements of three layers of said tabless-style electrode within end plate of said partially wound jelly roll of battery materials.

In FIG. 2, the three layers of said illustrated elements of said tabless-style electrode within end plate of said partially wound jelly roll of battery materials comprise, a middle layer comprising a wide irregular tab 105. In the three layers, a layer closer to the central winding axis (203) comprises two irregular more narrow elements of same tabless-style electrode (103/103). Furthermore, within the said three layers is illustrated elements of a layer further from the central axis of winding (201), said third layer illustrated to comprise two other relatively narrow irregular tabs (103/103) of same tabless style electrode.

It is understood that the spiral on left of FIG. 2 represents the winding process viewed from above, that is viewed as if looking down the central axis of the battery. In FIG. 2, illustration of partially complete winding of jelly roll comprising use of tabless-style electrode, is presented as spiral schematic on left and same process in magnified view on right, illustrating elements and relative contacts.

In FIG. 2, both views, spiral and magnified, are as from above end plate (looking down on partially wound jelly roll along central axis of cylinder of battery—not magnified/magnified). It is understood that winding first snugged the lowest illustrated layer 203 (comprising two narrow 103 elements), then snugged the next layer (comprising wider 105 element) and is in process of snugging layer at top of illustration (201—comprising two narrow 103 elements).

FIG. 2 schematic of end-plate of partially wound elements of tabless-style illustrates origin of what are herein termed arbitrary combinations of irregular tabs of a tabless-style electrode to form beneficial electrical connections. The elements of the closer to central winding axis 203 comprise irregular tabs (the left 103 and the right 103) which are face-to-face in contact to the lower face of the layer comprising 105 wider irregular tab element.

Furthermore, additional arbitrary combinations are illustrated in process of forming in FIG. 2 wherein layer 201 is being snugged during winding onto the previously snugged layer comprising wider irregular tab 105. This process of instant invention appears likely to render the left 103 lower face of layer 201 onto the upper face of element 105, establishing electrical contact.

Furthermore, as illustrated in FIG. 2, whereas layer 201 being snugged during winding onto layer comprising wider irregular tab 105, this winding process of instant invention appears likely to render the right 103 lower face of layer 201 onto the upper face of element 105, establishing electrical contact. Furthermore, said electron pathway capacity of said central wider irregular tab 105 is enabled to increase by said arbitrary combinations occurring during winding of jelly roll of battery materials, as illustrated. These contacts are established within end plate, layer upon layer, as disclosed.

It is understood that irregular tab electrode elements comprise said first illustrated layer, and other irregular tab elements comprise said second illustrated layer, and other irregular tab elements comprise said third illustrated layer, wherein all such irregular tab elements are within same tabless-style electrode. The various irregular tab elements contribute to increasing electron pathways, and at least potentially contribute to dissipation of heat from battery.

Furthermore, said arbitrary combinations enabled during layering, as disclosed herein, comprise at least one assembly wherein a central electrode element has face-to-face contact with any of one other element's face, two other elements' faces, three other elements' faces, or four other electrode elements' faces.

In a preferred embodiment, said face-to-face contacts comprise electrical connections and heat dissipating contacts. The lower layer 203, as illustrated in FIG. 2, comprises a bi-lobed in appearance element, said element comprising two irregular narrow tab components 103/103. Said components have a crack existing between them, between the 103/103 arrangement nearer to the 105 element's lower face. Meanwhile, the same 103/103 bi-lobed in appearance element has a remaining connection between the 103/103 arrangement at a location of element away from face-to-face contact to the wider element 105. Hence the bi-lobed in appearance element of layer 203 presents two faces of contact to underside face of element 105, while both faces can carry electrons and heat through a common area.

It is understood that the electrical connection of this battery in operation will comprise these pathways for electrons which traverse such face-to-face electrical connections and continue within contacted elements. Such contacts serve the needs of the battery in service to the external circuit. By such numerous pathways for electrons, the battery is enabled to operate with smoother power and less heat.

For example, cylindrical batteries are typically cooled from the sides, which leaves the core a problem for overheating. The instant invention providing of a ‘solid’ layer of metal within end plate provides for improved heat management of the battery core, a major benefit. Heat typically builds up due to the chemical processes of the battery and the insulating effects of the non-conducting layers within the core of the battery. Using instant invention, the entire metal layer of the electrode within the battery core and the metal of the end plate could become a heat sink.

Furthermore, the tabless-style electrode of instant invention comprises a shorter average electron path length, such as compared for example to a standard single welded tab battery's longer average electron path. Thus, instant invention enable battery to operate with less heat. By the disclosed method and system, the battery is also enabled to operate more efficiently, such as by improved rates of charge and discharge.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method comprising a step of enabling a tabless-style electrode to comprise irregular tabs.

2. The method of claim 1, further comprising a step of enabling irregular tabs without use of tab welding or etching.

3. The method of claim 1, further comprising a step of enabling said irregular tabs to arise within said tabless-style electrode in association with process comprising at least one of list: applying double-sided-coating to at least one tabless-style electrode, using in-tension tabless-style electrode processing, using dry powder process of for tabless-style electrode coating, using wet process of for tabless-style electrode coating, using heat drying of for tabless-style electrode, using roller to manipulate at least one tabless-style electrode, winding of jelly roll of battery materials.

4. The method of claim 1, further comprising a step of enabling said irregular tabs to comprise at least one of a variety of irregular configurations and a front face and rear face aspect.

5. A method for providing tab-enabled beneficial electrical connections within the end plate of a jelly roll of battery materials, said method comprising a step of winding within said jelly roll at least one tabless-style electrode, wherein said winding establishes within said jelly roll end plate at least one face-to-face electrical connection comprising in said connection at least a face of a first irregular tab of said tabless-style electrode, rendered by arbitrary combination into beneficial electrical contact with at least a face of at least a second irregular tab of said same electrode within said same wound jelly roll of battery materials end plate.

6. The method of claim 5, further comprising a step of using said winding of said tabless-style electrode to comprise, within one end plate, by arbitrary combining, electrical connections comprising at least one hundred irregular tabs.

7. The method of claim 5, further comprising a step of using, within winding of a jelly roll of battery materials, a plurality of tabless-style electrodes.

8. The method of claim 5, further comprising a step of using at least ten layers of winding of said tabless-style electrode in enabling beneficial electrical connections within a single end plate.

9. The method of claim 5, further comprising a step of-comprising said winding using irregular tabs comprising different widths, lengths, and irregularities of shape.

10. The method of claim 8, further comprising a step of establishing beneficial electrical face-to-face contact comprising at least one electrically interconnected group of irregular tabs deriving from at least three of said wound layers of said tabless-style electrode within said jelly roll end plate.

11. The method of claim 10, further comprising a step wherein said at least three layers comprise at least one assembly wherein a central irregular tab element of said tabless-style electrode has face-to-face electrical contact with at least four other irregular tab element faces.

12. The method of claim 11, further comprising a step wherein said at least one assembly comprises face-to-face electrical contact of at least two faces of irregular tab elements onto upper face of said central irregular tab element, and simultaneously face-to-face electrical contact of at least two other faces of other irregular tab elements of said same electrode onto lower face of said central irregular tab element.

13. The method of claim 6, further comprising at least one step of list: applying double-sided coating to at least one tabless-style electrode, using in-tension tabless-style electrode processing, using dry powder process for tabless-style electrode coating, using wet process for tabless-style electrode coating, using heat drying for tabless-style electrode, using roller to manipulate at least one tabless-style electrode.

14. The method of claim 13, further comprising a step of using said tabless-style electrode comprised end plate configuration to benefit at least one of battery heat management and battery efficiency.

15. A method for configuring a cylindrical battery comprising a step of configuring at least one electrode to comprise irregularities, said irregularities comprising at least one of: a crack, a hole, a split, a fissure, a wider than average tab, a narrower than average tab, a bi-lobed tab, a variation in tab shape one tab to another, a variation in tab size one tab to another, a variation in regularity of surface configuration one tab to another, and at least one tab comprising at least one fractured-off defect appearance, and wherein said tabs are further configured within electrical combinations/connections within winding of end plate of said battery, said winding comprising at least a second layer of said irregularly-tabbed electrode layered onto at least a preceding first layer of said same irregularly-tabbed electrode wound in end plate.

16. The method of claim 15, further comprising at least one step of list: applying coating of active materials comprising single-side electrode coating, applying coating of active materials comprising double-side electrode coating, manipulating at least one electrode comprising use of rollers, manipulating at least one electrode comprising use of electrode-in-tension process, heat drying of at least one electrode, wet coating of at least one electrode, dry coating of at least one electrode.

17. The method of claim 16, further comprising step of using said cylindrical battery for at least one of automotive use and energy use.

18. The method of claim 16, further comprising step of inducing at least one previously tabless area of at least one electrode to comprise at least one irregular tab, said induced irregular tab occurring within said electrode in association with at least one of electrode-related steps of list: processing, manipulating, coating, heating, wetting, drying, using rollers on electrode, using tension on electrode.

19. The method of claim 15, further comprising step of enabling said cylindrical battery to comprise at least one of smooth power supply and heat sink function.
